(19) United States
(12) Patent Application Publication
(10) Pub. No.: US 2026/0018969 A1
(43) Pub. Date: Jan. 15, 2026

(54) PISTON ASSEMBLY FOR A LINEAR ELECTRIC MACHINE

(71) Applicant: Hyliion Holdings Corp, Cedar Park, TX (US)

(72) Inventors: Victor Luis Marrero Ortiz, Humacao, PR (US); Jason Joseph Bellardi, Cincinnati, OH (US); Aigbedion Akwara, Cincinnati, OH (US)

(21) Appl. No.: 18/971,868

(22) Filed: Dec. 6, 2024

Related U.S. Application Data
(63) Continuation-in-part of application No. 18/771,335, filed on Jul. 12, 2024, now Pat. No. 12,281,626.

(51) Int. Cl. H02K 9/00; H02K 15/02; H02K 35/04

(52) U.S. Cl. CPC H02K 9/00; H02K 15/02; H02K 35/04; H02K 2209/00

(57) ABSTRACT

A linear electric machine includes a shaft and a piston assembly operably coupled with the shaft. The piston assembly includes a piston housing; and a piston arranged in the piston housing and partially defining each of an expansion chamber and a compression chamber within the piston housing. The piston includes a first portion in thermal contact with the compression chamber, a second portion in thermal contact with the expansion chamber, and a piston body extending from the first portion to the second portion. The piston body includes at least one heat shield configured to reduce heat transfer between the expansion chamber and the compression chamber. The at least one heat shield extends from an upper portion of the piston body to a lower portion of the piston body.

### CROSS-REFERENCE TO RELATED APPLICATIONS

This application is a continuation in part application of U.S. Application No. 18/771,335, filed July 12, 2024, which is hereby incorporated by reference in its entirety.

### FIELD

The present disclosure relates generally to linear electric machines, and more particularly to a piston assembly of a linear electric machine configured to minimize heat transfer from an expansion chamber to a compression chamber.

### BACKGROUND

Renewable power generation has become increasingly popular as conventional methods of producing power (such as via fossil fuels) has taken a toll on existing power grids. Such renewable power generation is effective at powering vehicles, electric vehicle (EV) chargers, residential properties, schools, hospitals, commercial buildings, and much more.

Large vehicles may be used to efficiently transport cargo. Large, wheeled vehicles pull trailers to transport large volumes of cargo on land, wherein the combination of the vehicle and the trailer can weigh between 30,000 pounds up to 140,000 pounds for a tandem loaded trailer. These vehicles may be referred to as “powered semi-tractors”, “semi-tractors”, “semis”, or “trucks.” Trucks may be used on roads such as highways and in urban areas but may also be used on unimproved roads or uneven terrain. In a traditional truck with an internal combustion engine, the internal combustion engine may be sized in the range of 15 liters to provide enough power to propel the vehicle and the trailer.

As described herein with respect to the present disclosure, such vehicles may be designed with unique configurations capable of integrating one of several different types of engines, such as a closed-cycle engine, that includes a piston assembly configured to minimize heat transfer from an expansion chamber to a compression chamber.

### BRIEF DESCRIPTION OF THE DRAWINGS

A full and enabling disclosure of the present disclosure, including the best mode thereof, directed to one of ordinary skill in the art, is set forth in the specification, which makes reference to the appended figures, in which:

FIG. 1 illustrates a side view of a wheeled vehicle capable of transporting cargo over an extended range in accordance with aspects of the present subject matter;

FIG. 2 illustrates a detailed, top view of a wheeled vehicle capable of transporting cargo over an extended range in accordance with aspects of the present subject matter;

FIG. 3 illustrates a perspective view of a closed-cycle engine for a vehicle in accordance with aspects of the present subject matter;

FIG. 4 illustrates a cross-sectional view of one of the closed-cycle engines taken along the line IV-IV of FIG. 3 in accordance with aspects of the present subject matter;

FIG. 5 illustrates a partial cross-sectional view of one of the piston assembly in accordance with aspects of the present subject matter; and

FIG. 6 illustrates a flow diagram of an embodiment of a method of manufacturing a piston assembly according to the present disclosure.

### DETAILED DESCRIPTION

Reference will now be made in detail to present embodiments of the disclosure, one or more examples of which are illustrated in the accompanying drawings. The detailed description uses numerical and letter designations to refer to features in the drawings. Like or similar designations in the drawings and description have been used to refer to like or similar parts of the present disclosure.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises... a” does not, without more constraints, preclude the existence of additional identical elements in the process, method, article, or apparatus that comprises the element.

As used herein, the terms “first,” “second,” and “third” may be used interchangeably to distinguish one component from another and are not intended to signify a location or importance of the individual components. The terms “coupled,” “fixed,” “attached to,” and the like refer to both direct coupling, fixing, or attaching, as well as indirect coupling, fixing, or attaching through one or more intermediate components or features, unless otherwise specified herein. The terms “upstream” and “downstream” refer to the relative direction with respect to a fluid within a fluid circuit. For example, “upstream” refers to the direction from which a fluid flows, and “downstream” refers to the direction to which the fluid moves. The term "selectively" refers to a component’s ability to operate in various states (e.g., an ON state and an OFF state) based on manual and/or automatic control of the component.

Furthermore, any arrangement of components to achieve the same functionality is effectively “associated” such that the functionality is achieved. Hence, any two components herein combined to achieve a particular functionality may be seen as “associated with” each other such that the desired functionality is achieved, irrespective of architectures or intermedial components. Likewise, any two components so associated may also be viewed as being “operably connected” or “operably coupled” to each other to achieve the desired functionality, and any two components capable of being so associated may also be viewed as being “operably couplable” to each other to achieve the desired functionality. Some examples of operably couplable include, but are not limited to, physically mateable, physically interacting components, wirelessly interactable, wirelessly interacting components, logically interacting, and/or logically interactable components.

The singular forms “a,” “an,” and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms, such as “about,” “approximately,” “generally,” and “substantially,” is not to be limited to the precise value specified. In at least some instances, the approximating language may correspond to the precision of an instrument for measuring the value, or the precision of the methods or apparatus for constructing or manufacturing the components and/or systems. For example, the approximating language may refer to being within a ten percent margin.

Moreover, the technology of the present application will be described in relation to exemplary embodiments. The word “exemplary” is used herein to mean “serving as an example, instance, or illustration.” Any embodiment described herein as “exemplary” is not necessarily to be construed as preferred or advantageous over other embodiments. Additionally, unless specifically identified otherwise, all embodiments described herein should be considered exemplary.

As used herein, the term “and/or,” when used in a list of two or more items, means that any one of the listed items may be employed by itself, or any combination of two or more of the listed items may be employed. For example, if a composition or assembly is described as containing components A, B, and/or C, the composition or assembly may contain A alone; B alone; C alone; A and B in combination; A and C in combination; B and C in combination; or A, B, and C in combination.

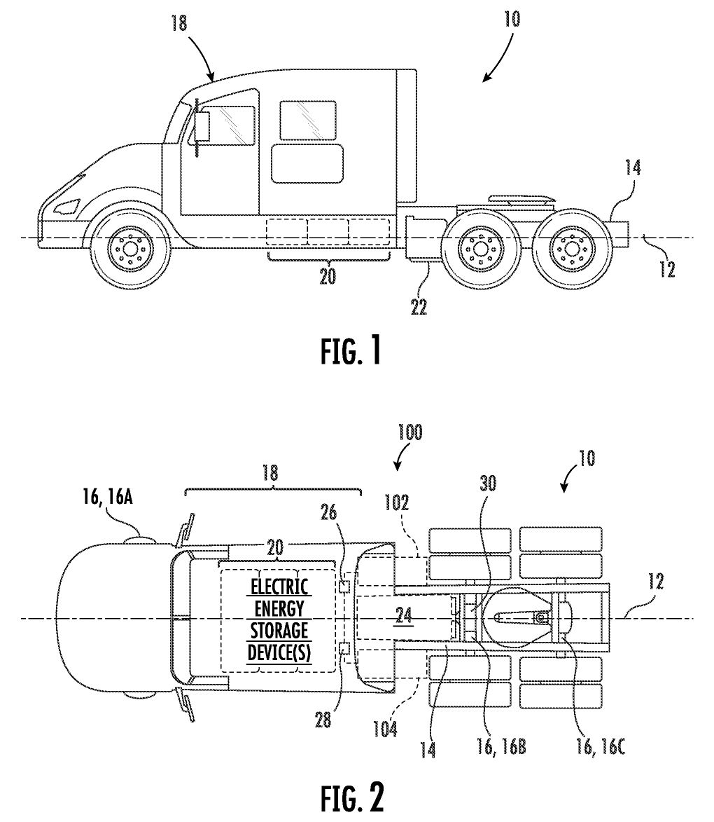

Referring now to the drawings, FIGS. 1 and 2 illustrate various views of a wheeled vehicle 10 along a fore/aft axis 12 according to the present disclosure. As shown generally in FIGS. 1 and 2, the vehicle 10 may include, but are not limited to, a chassis 14, which may support multiple axles 16 and/or a cab 18. In various examples, the chassis 14 may be formed with two frame members such as C-channels arranged parallel to each other. The one or more axles 16 may be operably coupled to the chassis 14. In some instances, the one or more axles 16 may include a front axle 16A and a pair of rear axles 16B, 16C.

Additionally, the vehicle 10 may include an engine assembly 100 that may include one or more closed-cycle engines 102, 104, an array of energy storage devices 20 (e.g., batteries), and/or a motor/generator 22 coupled to at least one of the axles 16. Moreover, the vehicle 10 may include one or more fuel tanks 24 operably coupled with the one or more closed-cycle engines 102, 104.

Furthermore, the vehicle 10 may be equipped with one or more power converters 26, 28 coupled to the closed-cycle engines 102, 104 and the array of energy storage devices 20. In some cases, an array of energy storage devices 20 may be positioned in various locations on the vehicle 10. For instance, the energy storage devices 20 may be located between the rails of the chassis 14, under the rails of the chassis 14, around the rails of the chassis 14, and/or in any other practicable location. Moreover, the array of energy storage devices 20 may be connected in series, parallel, and/or some combination. In operation, electric power generated by the motor/generator 22 may be used to charge the array of energy storage devices 20.

With further reference to FIGS. 1 and 2, the motor/generator 22 may be coupled to at least one of the axles 16. For example, in some instances, the motor/generator 22 may be integrated with one of the axles 16 as an e-axle configuration or located in a hub of a wheel coupled to one of the axles 16 as a hub motor/generator configuration. Additionally, or alternatively, the motor/generator 22 may be operably coupled to gearboxes or differentials of the vehicle 10. For example, the motor/generator 22 may be coupled to a three-speed centralized gearbox 30 with a two-speed rear differential 38 to provide six discrete gear ratios. In some examples, the vehicle 10 may be configured with a plurality of motors/generators 22, with a respective motor/generator 22 coupled to each wheel or pair of wheels.

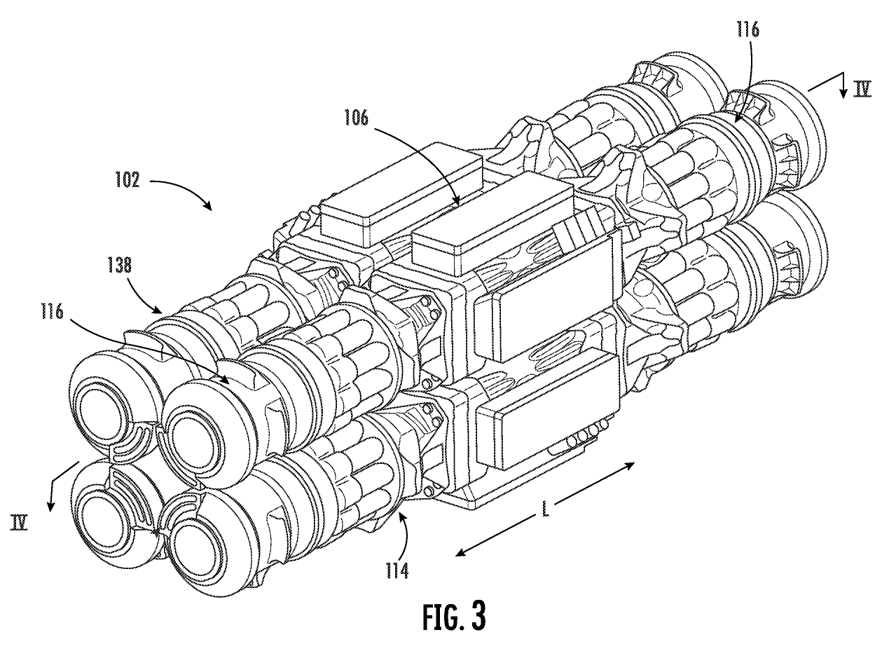

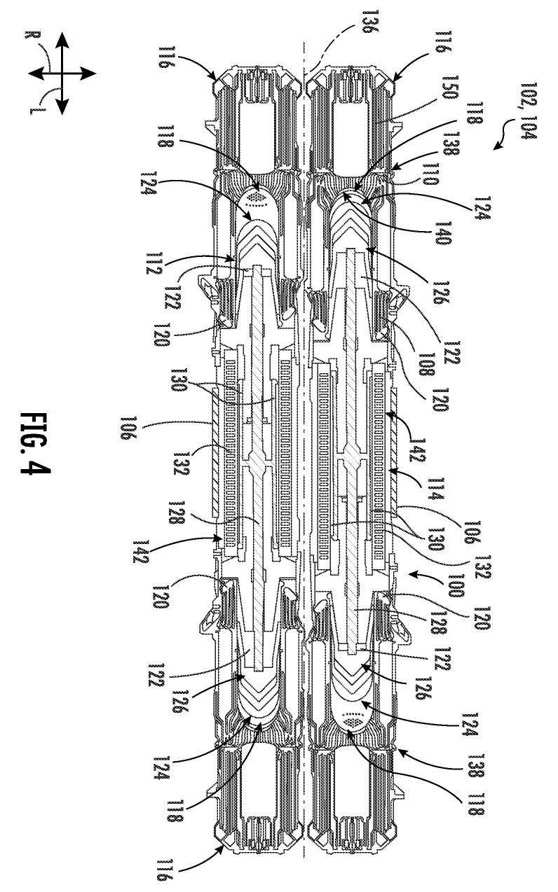

Referring now to FIGS. 3-5, one of the closed-cycle engines 102, 104 capable of being operably coupled to a load device 106 is illustrated according to various aspects of the present disclosure. As shown in FIGS. 3-5, the closed-cycle engine 102, 104 may contain an engine working fluid to which and from which thermal energy is exchanged at a respective cold side heat exchanger 108 and a hot side heat exchanger 110. In various instances, any suitable engine working fluid may be utilized in accordance with the present disclosure. For example, the engine working fluid may include a gas, such as an inert gas. For instance, a noble gas, such as helium may be utilized as the engine working fluid. In various cases, the working fluids may be inert, such that they generally do not participate in chemical reactions such as oxidation within the environment of the closed-cycle engine 102, 104. Various noble gasses that may be utilized by the closed-cycle engine 102, 104 may include monoatomic gases, such as helium, neon, argon, krypton, or xenon, as well as combinations of these. In several examples, the engine working fluid may include air, oxygen, nitrogen, hydrogen, carbon dioxide, any other practicable fluid, as well as combinations of these. In still various instances, the engine working fluid may be liquid fluids of one or more elements described herein, or combinations thereof. It will be appreciated that various examples of the engine working fluid may include particles or other substances as appropriate for the engine working fluid.

In various cases, the load device 106 is a mechanical work device or an electric machine. For example, the load device 106 may be a pump, compressor, or other work device. Additionally, or alternatively, the load device 106 may be an electric machine that is configured as a generator producing electric energy from the movement of a piston assembly 112 at the closed-cycle engine 102, 104. In still another example, the electric machine may be configured as a motor that may provide motive force to move or actuate the piston assembly 112, such as to provide initial movement (e.g., a starter motor). In still various examples, the electric machine may be configured as a motor and generator or another electric machine.

As illustrated in FIGS. 3-5, the closed-cycle engine 102, 104 may include an engine body 114 and a pair of housings 116 disposed on opposing sides of the engine body 114. For example, a first housing 116 may be disposed at a first side portion of the engine body 114 and a second housing 116 may be disposed at a second side portion of the engine body 114. In still other examples, a plurality of engine bodies 114 may be provided, and/or a single housing 116 or a multitude of housings 116 may be provided.

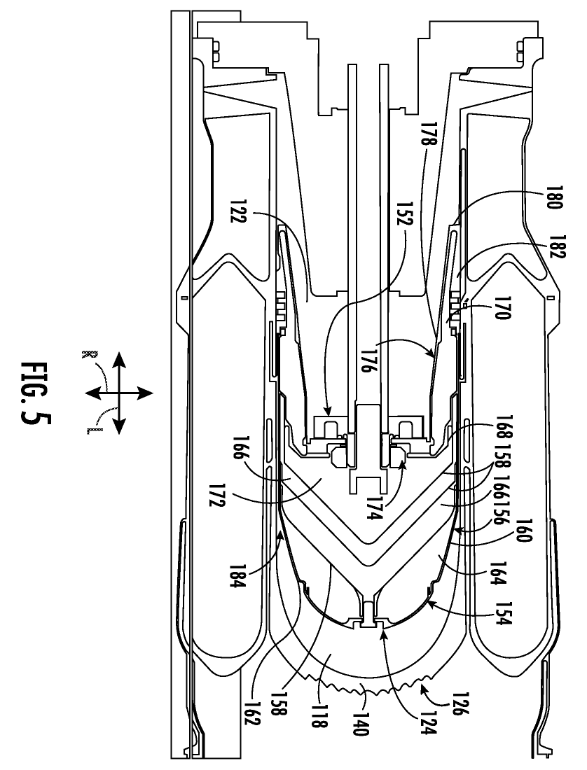

In various embodiments, as shown in FIG. 4, the hot side heat exchanger 110 may output thermal energy to the engine working fluid at an expansion chamber 118 of the closed-cycle engine 102, 104. The hot side heat exchanger 110 may be positioned proximate to the expansion chamber 118 of the engine in thermal communication with the housing 116. In other examples, the hot side heat exchanger 110 may be separate from the housing 116, such that the heating working fluid is provided in thermal communication, or additionally, in fluid communication with the hot side heat exchanger 110. In some cases, the hot side heat exchanger 110 may be positioned in thermal communication with the housing 116 and the expansion chamber 118 of the closed-cycle engine 102, 104 such as to receive thermal energy from the housing 116 and provide thermal energy to the engine working fluid within the closed-cycle engine 102, 104.

In still various examples, the housing 116 may include a single thermal energy output source to a single expansion chamber 118 of the engine. As such, the closed-cycle engine 102, 104 may include a plurality of heater assemblies each providing thermal energy to the engine working fluid at each expansion chamber 118. In other embodiments, such as depicted in regard to FIG. 4, the housing 116 may provide thermal energy to a plurality of expansion chambers 118 of the closed-cycle engine 102, 104.

The closed-cycle engine 102, 104 may further include a chiller assembly 120. The chiller assembly 120 may be configured to receive and displace thermal energy from a compression chamber 122 of the closed-cycle engine 102, 104. Additionally, the cold side heat exchanger 108 may be thermally coupled to the compression chamber 122 of the closed cycle engine 102, 104, and the chiller assembly 120. In some instances, the cold side heat exchanger 108 and a piston housing 126 defining the compression chamber 122 of the closed-cycle engine 102, 104 may together be defined as an integral, unitary structure. In still various examples, the cold side heat exchanger 108, at least a portion of the piston housing 126 defining the compression chamber 122, and at least a portion of the chiller assembly 120 may together define an integral, unitary structure.

In various embodiments, as shown in FIG. 4, the chiller assembly 120 may be a bottoming cycle to the closed-cycle engine 102, 104. As such, the chiller assembly 120 may be configured to receive thermal energy from the closed-cycle engine 102, 104. The thermal energy received at the chiller assembly 120, such as through a cold side heat exchanger 108, may be added to a chiller working fluid at the chiller assembly 120. In various examples, the chiller assembly 120 defines a Rankine cycle system through which the chiller working fluid flows in a closed loop arrangement with a compressor. In some examples, the chiller working fluid may be in a closed-loop arrangement with an expander. In various cases, the cold side heat exchanger 108 may include a condenser or radiator. The cold side heat exchanger 108 may be positioned downstream of the compressor and upstream of the expander and in thermal communication with the compression chamber 122 of the closed-cycle engine 102, 104. In various embodiments, the cold side heat exchanger 108 may generally define an evaporator receiving thermal energy from the closed-cycle engine 102, 104.

Various examples of the closed-cycle engine 102, 104 may include control systems and methods of controlling various sub-systems disclosed herein, such as, but not limited to, the fuel source, the oxidizer source, the cooling fluid source, the housing 116, the chiller assembly 120, and the load device 106, including any flow rates, pressures, temperatures, loads, discharges, frequencies, amplitudes, or other suitable control properties associated with the closed-cycle engine 102, 104.

In some examples, the control system may control the closed-cycle engine 102, 104 to generate a temperature differential, such as a temperature differential at the engine working fluid relative to the heating working fluid and the chiller working fluid. Thus, the closed-cycle engine 102, 104 defines a hot side, such as at the expansion chamber 118, and a cold side, such as at the compression chamber 122. The temperature differential causes free piston assemblies 112 to move within their respective piston housings 126. The movement of pistons 124 within the respective piston housings 126 causes the electric machine to generate electrical power. The generated electrical power may be provided to the energy storage devices 20 for charging thereof. The control system monitors one or more operating parameters associated with the closed-cycle engine 102, 104, such as piston movement (e.g., amplitude and position), as well as one or more operating parameters associated with the electric machine, such as voltage or electric current. Based on such parameters, the control system generates control commands that are provided to one or more controllable devices of the closed-cycle engine 102, 104. The controllable devices execute control actions in accordance with the control commands. Accordingly, the desired output of the closed-cycle engine 102, 104 may be achieved.

Referring still to FIG. 4, each piston assembly 112 may be positioned within a volume or piston housing 126. The volume within the piston housing 126 is separated into a first chamber, or hot chamber, or expansion chamber 118 and a second chamber, or cold chamber (relative to the hot chamber), or compression chamber 122 by a piston 124 of the piston assembly 112. The expansion chamber 118 may be positioned thermally proximally to the housing 116 relative to the compression chamber 122 thermally distal to the housing 116. The compression chamber 122 may be positioned thermally proximal to the chiller assembly 120 relative to the expansion chamber 118 thermally distal to the chiller assembly 120.

In various instances, the piston assembly 112 may be configured as a double-ended piston assembly 112 in which a pair of pistons 124 is each coupled to a connection member 128. The connection member 128 may generally define a rigid shaft or rod extended along a direction of motion of the piston assembly 112. In other instances, the connection members 128 may include one or more springs or spring assemblies, such as further provided herein, providing flexible or non-rigid movement of the connection member 128. In still other instances, the connection member 128 may further define substantially U-shaped connections or V-shaped connections between the pair of pistons 124.

Each piston 124 may be positioned within the piston housing 126 such as to define the expansion chamber 118 and the compression chamber 122 within the volume of the piston housing 126. In operation, combustion may occur within the expansion chamber 118 causing the piston 124 to move from a first position to a second position in a longitudinal direction L. The load device 106 may be operably coupled to the piston assembly 112 such as to extract energy therefrom, provide energy thereto, or both. The load device 106 may define an electric machine that is in magnetic communication with the closed-cycle engine 102, 104 via the connection member 128. In various examples, the piston assembly 112 may include a load member 130 positioned in operable communication with a stator assembly 132 of the electric machine. The stator assembly 132 may generally include a magnet array and a plurality of windings wrapped circumferentially relative to the piston assembly 112 and extended along the longitudinal direction L. In some instances, such as depicted in regard to FIG. 4, the load member 130 is connected to the connection member 128. In some examples, the linear motion of the load member 130 in conjunction with the piston assembly 112 may generate electricity via the magnetic communication between the stator assembly 132 and the load member 130.

Referring still to FIG. 4, in various embodiments, the hot side heat exchanger 110 may further define at least a portion of the expansion chamber 118. In some cases, the hot side heat exchanger 110 defines a unitary or monolithic structure with at least a portion of the piston housing 126, such as to define at least a portion of the expansion chamber 118. In some embodiments, the housing 116 may further define at least a portion of the hot side heat exchanger 110, such as to define a unitary or monolithic structure with the hot side heat exchanger 110.

Furthermore, as shown in FIGS. 3-6, the piston housing 126 may define a dome structure 140 within the expansion chamber 118. In such embodiments, the dome structure 140 may provide reduced surface area heat losses across an outer end of the expansion chamber 118. In various instances, the pistons 124 of the piston assembly 112 may also include domed pistons 124 corresponding to the dome structure 140. The dome structure 140, the domed piston 124, or both may provide higher compression ratios at the chambers 118, 122, such as to improve power density and output. Moreover, as shown, the piston housing 126 further defines an exterior surface 138 corresponding to a shape of the dome structure 140.

In various examples, such as the one shown in FIG. 4, the load device 106 may be positioned at the interior section 134 of the closed-cycle engine 102, 104 between laterally opposing pistons 124. The load device 106 may further include a machine body 142 positioned laterally between the piston housings 126. The machine body 142 surrounds and houses the stator assembly 132 of the load device 106 defining the electric machine. The machine body 142 may further surround the load member 130 of the electric machine attached to the connection member 128 of the piston assembly 112.

Referring now to FIGS. 3-6, in some examples, the closed-cycle engine 102, 104 may include the engine body 114 and the pair of housings 116 disposed on opposing sides of the engine body 114, one of which is illustrated in FIG. 5. In various examples, the housing 116 may include a heater body 150 (also referred to herein as a recuperator 150) positioned at the outer end of the expansion chamber 118 adjacent to the dome structure 140. The recuperator 150 may include or be operably coupled with an intake fluid channel (not numbered) that defines an intake fluid pathway (not numbered), a discharge channel (not numbered) that defines a discharge pathway (not numbered), and/or a heat exchanger channel (not numbered) that defines an exhaust gas pathway (not numbered) from the heat exchanger 110 to the recuperator 150.

In some instances, the intake fluid channel may define at least a portion of an intake fluid pathway that provides intake fluid to the recuperator 150. In some cases, the intake fluid may be pressurized, such as via a compressor (not shown), to induce a flow of intake fluid into the intake fluid pathway. The heat exchanger channel may provide exhaust gas from the heat exchanger 110 to the recuperator 150. In turn, the intake fluid and the exhaust gas mix and provide a first portion of a fresh combustion gas to a combustion chamber/mixing conduit (not numbered) via an exhaust gas recirculation (EGR) ejector (not numbered). The first portion of the fresh combustion gas may be directed into the expansion chamber 118 while a fuel nozzle introduces a flow of fuel, which may include a liquid, gaseous fuel. A second portion of the fresh combustion gas may be directed to the discharge channel, which is then discharged from the housing 116 along the discharge pathway.

In the expansion chamber 118, the fuel combines with the first portion of the fresh combustion gas and is ignited, for example, by a glow plug or a spark plug. The expansion chamber 118 may provide a vortex combustion pattern with a circular flow. The centripetal force of the vortex combustion pattern may draw the combustion flame radially or concentrically inward while propelling unburnt combustion gas radially or concentrically outward. The exhaust gas may be exhausted from the expansion chamber 118 and into the hot-side heat exchanger 110. The exhaust gas may flow from the hot-side heat exchanger 110 to the recuperator 150 to become the exhaust gas that may then be provided to the recuperator 150.

Referring particularly to FIG. 5, a cross-sectional view of a portion of a linear electric machine, such as the closed cycle engine 102, 104, is illustrated. More specifically, as shown, the piston 124 includes a first portion 152 in thermal contact with the compression chamber 122, a second portion 154 in thermal contact with the expansion chamber 118, and a piston body 156 extending from the first portion 152 to the second portion 154. Further, the piston 124 is configured to thermally isolate the expansion chamber 118 from the compression chamber 122. Furthermore, the piston 124 is configured to increase a conduction path between the expansion chamber 118 and the compression chamber 122 so as to reduce heat transfer through the piston 124. Moreover, as shown, the piston body 156 further includes at least one heat shield 158 extending from an upper portion 160 of the piston body 156 to a lower portion 162 of the piston body 156. The heat shield(s) 158 is configured to further reduce heat transfer (e.g., via conduction and/or radiation) between the expansion chamber 118 and the compression chamber 122 (i.e., through the piston 124).

Furthermore, the upper portion 160 may be spaced from the lower portion 162 in a radial direction R that is orthogonal to the longitudinal direction L. The upper portion 160 may be arranged radially outward of the lower portion 162 relative to the axis 136 (e.g., see FIG. 4). That is, the lower portion 162 may be arranged radially between the axis 136 and the upper portion 160.

Further, the first portion 152 may be formed of any suitable material (e.g., titanium or another suitable metal or metal alloy). In addition, the piston body 156 may be formed of any suitable material (e.g., a metal or metal alloy, such as cobalt chrome, or any other suitable material for reducing the heat transfer through the piston 124). The piston body 156 and the first portion 152 may be formed of a same or different material. When the piston body 156 and the first portion 152 are formed of different materials, the piston body 156 and the first portion 152 may be formed separately and subsequently connected to each other (e.g., via fasteners, welding, adhesives, or any other suitable connection technique). When the piston body 156 and the first portion 152 are formed of a same material, the piston body 156 and the first portion 152 may be formed integrally with each other (e.g., via additive manufacturing techniques).

Additionally, the second portion 154 may be formed of any suitable material (e.g., stainless steel or another suitable metal or metal alloy). The second portion 154 may be formed of a different material than the piston body 156. In such an example, the second portion 154 and the piston body 156 may be formed separately. As such, the second portion 154 may be subsequently connected (e.g., via fasteners, welding, adhesives, or any other suitable connection technique) to the piston body 156 and/or a fastening mechanism that is connected to a heat shield 158. Alternatively, the second portion 154, the first portion 152, and the piston body 156 may be formed of a same material. In such an example, the piston body 156, the first portion 152, and the second portion 154 may be formed integrally with each other (e.g., via additive manufacturing techniques).

Still referring to FIG. 5, in embodiments, as shown, the heat shield(s) 158 may be spaced from the second portion 154 and/or the first portion 152. In such an embodiment, the heat shield(s) 158 and the first portion 152 and/or the second portion 154 may define a first cavity 164 therebetween. The first cavity 164 may be configured to further reduce the heat transfer between the expansion chamber 118 and the compression chamber 122. For example, the first cavity 164 may be filled with air (or some other fluid or insulating material) so as to form a thermal gap between the heat shield(s) 158 and the first portion 152 and/or the second portion 154. The first cavity 164 may function as a thermal barrier to resist heat transfer (e.g., due to relatively low thermal conductivity of air) through the piston 124 (i.e., between the expansion chamber 118 and the compression chamber 122).

In an embodiment, as shown, the piston body 156 may include a plurality of heat shields 158 configured to reduce heat transfer between the expansion chamber 118 and the compression chamber 122. At least some of the heat shields 158 may be spaced from each other in the longitudinal direction L, as shown. Moreover, one or more of the heat shields 158 may extend from the upper portion 160 to the lower portion 162. In certain embodiments, at least two of the plurality of heat shields 158 may define a second cavity 166 therebetween. The second cavity 166 may be configured to further reduce the heat transfer between the expansion chamber 118 and the compression chamber 122. For example, the second cavity 166 may form a thermal gap in a same or similar manner as discussed above regarding the first cavity 164. Furthermore, in embodiments, the piston body 156 may include one or more second cavities 166. For example, as shown, the piston body 156 may include one first cavity 164 between one heat shield 158 and the first portion 152, and two second cavities between respective heat shields 158.

In further embodiments, the first and second cavities 164, 166 may extend from the upper portion 160 to the lower portion 162 of the piston body 156. That is, the air (or other fluid or insulating material) within the first and second cavities 164, 166 may be permitted to flow through the respective cavities 164, 166 from the upper portion 160 to the lower portion 162. Said differently, the thermal gaps formed by the first and second cavities 164, 166 may extend across the piston body 156 from the upper portion 160 to the lower portion 162. In additional or alternative embodiments, one heat shield 158 may extend from (i.e., be stacked on) another heat shield 158 (FIG. 4). In such examples, the one heat shield 158 and the other heat shield 158 may define a cavity therebetween that is spaced from at least one of the upper portion 160 and the lower portion 162. The heat shield(s) 158 may have a thickness that is less than a thickness of the upper portion 160 and/or a thickness of the lower portion 162.

Still referring to FIG. 5, in embodiments, as shown, the piston body 156 may include a connection portion 168. The connection portion 168 may extend from the first portion 152 to one of the heat shields 158. The connection portion 168 may, for example, be configured to connect to at least one of the first portion 152 and the one of the heat shields 158 (e.g., when the first portion 152 and the piston body 156 are formed of different materials). In such embodiments, the connection portion 168 may be connected to the at least one of the first portion 152 and the one of the heat shields 158 in any suitable manner (e.g., via fasteners, adhesives, or known joining techniques such as welding, etc.).

Additionally, or alternatively, the connection portion 168 may be integrally formed with the at least one of the first portion 152 and the one of the heat shields 158 (e.g., when the first portion 152 and the piston body 156 are formed of a same material (e.g., via additive manufacturing techniques)). Moreover, the connection portion 168 may, for example, be configured to further reduce the heat transfer between the expansion chamber 118 and the compression chamber 122. That is, the connection portion 168 may be configured substantially similar to the heat shield(s) 158.

Furthermore, in embodiments, as shown, the connection portion 168 may partially define a third cavity 170 and a fourth cavity 172. The third and fourth cavities 170, 172 each may be configured to further reduce the heat transfer between the expansion chamber 118 and the compression chamber 122. For example, the third and fourth cavities 170, 172 each may form respective thermal gaps, as explained above. As shown in FIG. 5, the third cavity 170 (e.g., on radially outer sides thereof relative to the radial direction R) may be further partially defined by the upper portion 160, the lower portion 162 and/or the one of the heat shields 158. Moreover, the third cavity 170 (e.g., on radially inner sides thereof relative to the radial direction R) may be further partially defined by the first portion 152. In addition, as shown in FIG. 5, the fourth cavity 172 may be spaced from the upper portion 160 and the lower portion 162. For example, as shown, the fourth cavity 172 may be further partially defined by the one of the heat shields 158. More particularly, the fourth cavity 172 may be bound in the radial direction R by the one of the heat shields 158. Further, the fourth cavity 172 may be bound in the longitudinal direction L by the one of the heat shields 158, the connection portion 168, and the first portion 152.

Still referring to FIG. 5, in embodiments, as shown, the first portion 152 may include a mounting portion 174 and a cover portion 176 extending from the mounting portion 174. The cover portion 176 may include an inner portion 178 extending from the mounting portion 174 to an end 180 spaced from the piston body 156.

In addition, the cover portion 176 may include an outer portion 182 arranged radially between the inner portion 178 and the piston housing 126 relative to the radial direction R. The cover portion 176 may, for example, be folded at the end 180 so as to define the inner portion 178 and the outer portion 182. The outer portion 182 may be spaced from the mounting portion 174 relative to the longitudinal direction L. The outer portion 182 may extend from the end 180 towards the piston body 156. More particularly, the outer portion 182 may extend to the piston body 156. In some embodiments, the outer portion 182 may, for example, be configured to connect to the piston body 156 (e.g., when the first portion 152 and the piston body 156 are formed of different materials). The outer portion 182 may be connected to the piston body 156 in any suitable manner (e.g., via fasteners, adhesives, or known joining techniques such as welding, etc.). Alternatively, the outer portion 182 and the piston body 156 may be integrally formed with each other (e.g., when the first portion 152 and the piston body 156 are formed of a same material (e.g., via additive manufacturing techniques)).

Moreover, the outer portion 182 may terminate partially between the end 180 and the mounting portion 174 relative to the longitudinal direction L. That is, the piston body 156 may extend, at least partially, between the mounting portion 174 and the end 180 of the cover portion 176 relative to the longitudinal direction L, as shown. In an embodiment, at least one heat shield 158 may extend, at least partially, between the mounting portion 174 and the end 180 of the cover portion 176 relative to the longitudinal direction L, as shown. That is, at least a portion of at least one heat shield 158 may be arranged between the mounting portion 174 and the outer portion 182 relative to the longitudinal direction L. Further, the connection portion 168 may be arranged, at least partially, between the mounting portion 174 and the outer portion 182, as shown.

In addition, the piston body 156 may be spaced from the piston housing 126 such that the piston housing 126 and the piston body 156 define a gap 184 therebetween. As shown, the gap 184 may extend at least partially between the mounting portion 174 and the end 180 of the cover portion 176 relative to the longitudinal direction L. That is, the gap 184 may partially overlap the inner portion 178 relative to the radial direction R. Said differently, a line extending orthogonal to the axis 136 may extend through the inner portion 178 and the gap 184. The gap 184 (e.g., a thickness determined relative to the radial direction R and/or a length determined relative to the longitudinal direction L) may be configured to further reduce heat transfer between the expansion chamber 118 and the compression chamber 122 and/or based on a stroke of the piston assembly 112.

Furthermore, as shown in FIG. 5, the cover portion 176, and more specifically, the outer portion 182, may be sealed to the piston housing 126. The cover portion 176 may be sealed to the piston housing 126 via any suitable manner (e.g., via pneumatic seals, bonded seals, or any other known sealing technique) so as to fluidly and thermally seal the expansion chamber 118 from the compression chamber 122. The outer portion 182 may be sealed to the piston housing 126 between the end 180 and a connection to the piston body 156, as shown. As such, the piston body 156 may be in thermal contact with the expansion chamber 118. In other words, the gap 184 may be arranged in the expansion chamber 118. Accordingly, the end 180 and the inner portion 178 of the cover portion 176 may be in thermal contact with the compression chamber 122.

Further, the mounting portion 174 may be configured to connect to the connection member 128. For example, as shown, the mounting portion 174 may be connected to the connection member 128 via a fastener received by each of the mounting portion 174 and the connection member 128. However, it should be understood that other suitable techniques (e.g., welding, adhesives, etc.) are possible for connecting the mounting portion 174 to the connection member 128. In addition, the mounting portion 174 may be configured to connect to the piston body 156, and more specifically, to the connection portion 168, as shown. The mounting portion 174 may be connected to the piston body 156 in any suitable manner (e.g., via fasteners, adhesives, or known joining techniques such as welding, etc.). Alternatively, the mounting portion 174 and the piston body 156 may be integrally formed with each other (e.g., when the first portion 152 and the piston body 156 are formed of a same material (e.g., via additive manufacturing techniques)).

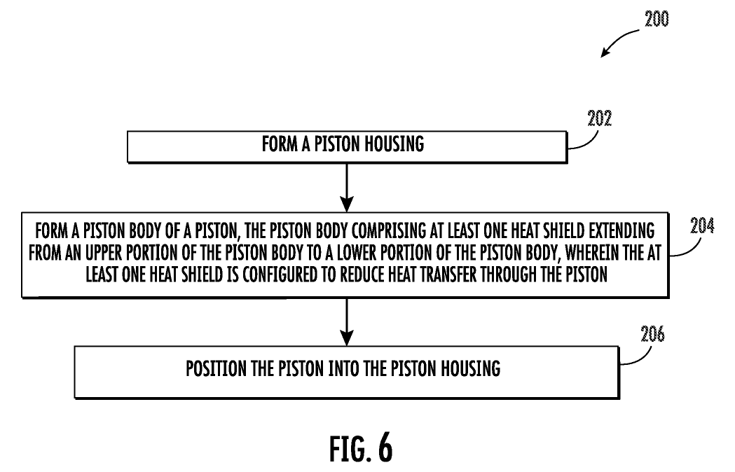

Referring now to FIG. 6, a flow diagram of an embodiment of a method 200 of manufacturing a piston assembly is illustrated according to the present disclosure. In general, the method 200 of FIG. 6 will be described herein with reference to the piston assembly 112 of FIGS. 1-5. However, it should be appreciated that the disclosed method 200 may apply to other configurations of piston assemblies having any suitable configuration. In addition, although FIG. 6 depicts steps performed in a particular order for purposes of illustration and discussion, the methods described herein are not limited to any particular order or arrangement. One skilled in the art, using the disclosures provided herein, will appreciate that various steps of the methods can be omitted, rearranged, combined and/or adapted in various ways.

As shown at (202), the method 200 includes forming a piston housing 126. As mentioned, the piston housing 126 may define an expansion chamber 118, a compression chamber 122, and a dome structure 140 at the expansion chamber 118. As shown at (204), the method 200 includes forming a piston body 156 of a piston 124 via additive manufacturing. Further, the piston body 156 includes at least one heat shield 158 (also formed via additive manufacturing) extending from an upper portion 160 of the piston body 156 to a lower portion 162 of the piston body 156. Thus, the heat shield(s) 158 is configured to reduce heat transfer through the piston 124. In some embodiments, the piston body 156 may further include a plurality of heat shields 158. In such embodiments, the plurality of heat shields 158 may be spaced from each other in a longitudinal direction L and may extend from the upper portion 160 to the lower portion 162 of the piston body 156. In embodiments, the heat shield(s) 158 may partially define at least one cavity 164, 166 configured to further reduce the heat transfer through the piston 124. In such embodiments, the cavity(ies) 164, 166 may extend from the upper portion 160 to the lower portion 162 of the piston body 156. Referring still to FIG. 6, as shown at (206), the method 200 includes positioning the piston 124 into the piston housing 126 to form the piston assembly 112.

Further aspects are provided by the subject matter of the following clauses:

A linear electric machine, comprising: a shaft; a piston assembly operably coupled with the shaft, the piston assembly comprising: a piston housing; and a piston arranged in the piston housing and partially defining each of an expansion chamber and a compression chamber within the piston housing, the piston comprising a first portion in thermal contact with the compression chamber, a second portion in thermal contact with the expansion chamber, and a piston body extending from the first portion to the second portion; wherein the piston body comprises at least one heat shield configured to reduce heat transfer between the expansion chamber and the compression chamber, the at least one heat shield extending from an upper portion of the piston body to a lower portion of the piston body.

The linear electric machine of any preceding clause, wherein the at least one heat shield is spaced from at least one of the second portion and the first portion, the at least one heat shield and the at least one of the first portion and the second portion defining a cavity therebetween configured to reduce the heat transfer between the expansion chamber and the compression chamber.

The linear electric machine of any preceding clause, wherein the piston body comprises a plurality of heat shields configured to reduce the heat transfer between the expansion chamber and the compression chamber, the at least one heat shield being one of the plurality of heat shields, the plurality of heat shields being spaced from each other in an longitudinal direction and extending from the upper portion to the lower portion of the piston body.

The linear electric machine of any preceding clause, wherein at least two of the plurality of heat shields define a cavity therebetween configured to reduce the heat transfer between the expansion chamber and the compression chamber.

The linear electric machine of any preceding clause, wherein the cavity extends from the upper portion to the lower portion.

The linear electric machine of any preceding clause, wherein the piston body further comprises a connection portion configured to reduce the heat transfer between the expansion chamber and the compression chamber, the connection portion extending from the first portion to the heat shield.

The linear electric machine of any preceding clause, wherein the connection portion partially defines a first cavity and a second cavity each configured to reduce the heat transfer between the expansion chamber and the compression chamber, the first cavity being further partially defined by the piston body, and the second cavity being spaced from the piston body.

The linear electric machine of any preceding clause, wherein the piston body is in thermal contact with the expansion chamber.

The linear electric machine of any preceding clause, wherein the first portion comprises a mounting portion and a cover portion extending from the mounting portion, the cover portion being sealed to the piston housing; and wherein the piston body extends to the cover portion and is spaced from the piston housing such that the piston housing and the piston body define a gap therebetween, the gap extending at least partially between the mounting portion and an end of the cover portion relative to a longitudinal direction.

The linear electric machine of any preceding clause, wherein the at least one heat shield is arranged, at least partially, between the mounting portion and an end of the cover portion relative to the longitudinal direction.

The linear electric machine of any preceding clause, wherein the linear electric machine is a closed-cycle engine.

An engine body, comprising: a piston housing; and a piston arranged in the piston housing and partially defining each of an expansion chamber and a compression chamber within the piston housing, the piston comprising a first portion in thermal contact with the compression chamber, a second portion in thermal contact with the expansion chamber, and a piston body extending from the first portion to the second portion; wherein the piston body comprises at least one heat shield configured to reduce heat transfer between the expansion chamber and the compression chamber, the at least one heat shield extending from an upper portion of the piston body to a lower portion of the piston body.

The engine body of any preceding clause, wherein the at least one heat shield is spaced from at least one of the second portion and the first portion, the at least one heat shield and the at least one of the first portion and the second portion defining a cavity therebetween configured to reduce the heat transfer between the expansion chamber and the compression chamber.

The engine body of any preceding clause, wherein the piston body further comprises a plurality of heat shields configured to reduce the heat transfer between the expansion chamber and the compression chamber, the at least one heat shield being one of the plurality of heat shields; wherein the plurality of heat shields are spaced from each other in an longitudinal direction and extending from the upper portion to the lower portion of the piston body; wherein at least two of the plurality of heat shields define a cavity therebetween configured to reduce the heat transfer between the expansion chamber and the compression chamber.

The engine body of any preceding clause, wherein the cavity extends from the upper portion to the lower portion.

The engine body of any preceding clause, wherein the piston body is in thermal contact with the expansion chamber.

A method of manufacturing a piston assembly, the method comprising: forming a piston housing; forming a piston body of a piston via additive manufacturing, the piston body comprising at least one heat shield extending from an upper portion of the piston body to a lower portion of the piston body, wherein the at least one heat shield is configured to reduce heat transfer through the piston; and positioning the piston into the piston housing.

The method of any preceding clause, wherein forming the piston body of the piston comprising the at least one heat shield extending from the upper portion of the piston body to the lower portion of the piston body further comprises utilizing an additive manufacturing process to form the piston body and the at least one heat shield.

The method of any preceding clause, wherein the piston body comprises a plurality of heat shields configured to reduce the heat transfer through the piston, the at least one heat shield being one of the plurality of heat shields, the plurality of heat shields being spaced from each other in an longitudinal direction and extending from the upper portion to the lower portion of the piston body.

The method of any preceding clause, wherein the at least one heat shield partially defines at least one cavity configured to further reduce the heat transfer through the piston, the at least one cavity extending from the upper portion to the lower portion of the piston body.

This written description uses examples to disclose the present disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

We claim:

1. A linear electric machine, comprising:
a shaft;
a piston assembly operably coupled with the shaft, the piston assembly comprising:
a piston housing; and
a piston arranged in the piston housing and partially defining each of an expansion chamber and a compression chamber within the piston housing, the piston comprising a first portion in thermal contact with the compression chamber, a second portion in thermal contact with the expansion chamber, and a piston body extending from the first portion to the second portion;
wherein the piston body comprises at least one heat shield configured to reduce heat transfer between the expansion chamber and the compression chamber, the at least one heat shield extending from an upper portion of the piston body to a lower portion of the piston body.

2. The linear electric machine of claim 1, wherein the at least one heat shield is spaced from at least one of the second portion and the first portion, the at least one heat shield and the at least one of the first portion and the second portion defining a cavity therebetween configured to reduce the heat transfer between the expansion chamber and the compression chamber.

3. The linear electric machine of claim 1, wherein the piston body comprises a plurality of heat shields configured to reduce the heat transfer between the expansion chamber and the compression chamber, the at least one heat shield being one of the plurality of heat shields, the plurality of heat shields being spaced from each other in an longitudinal direction and extending from the upper portion to the lower portion of the piston body.

4. The linear electric machine of claim 3, wherein at least two of the plurality of heat shields define a cavity therebetween configured to reduce the heat transfer between the expansion chamber and the compression chamber.

5. The linear electric machine of claim 4, wherein the cavity extends from the upper portion to the lower portion.

6. The linear electric machine of claim 3, wherein the piston body further comprises a connection portion configured to reduce the heat transfer between the expansion chamber and the compression chamber, the connection portion extending from the first portion to the heat shield.

7. The linear electric machine of claim 6, wherein the connection portion partially defines a first cavity and a second cavity each configured to reduce the heat transfer between the expansion chamber and the compression chamber, the first cavity being further partially defined by the piston body, and the second cavity being spaced from the piston body.

8. The linear electric machine of claim 1, wherein the piston body is in thermal contact with the expansion chamber.

9. The linear electric machine of claim 1,
wherein the first portion comprises a mounting portion and a cover portion extending from the mounting portion, the cover portion being sealed to the piston housing; and
wherein the piston body extends to the cover portion and is spaced from the piston housing such that the piston housing and the piston body define a gap therebetween, the gap extending at least partially between the mounting portion and an end of the cover portion relative to a longitudinal direction.

10. The linear electric machine of claim 9, wherein the at least one heat shield is arranged, at least partially, between the mounting portion and an end of the cover portion relative to the longitudinal direction.

11. The linear electric machine of claim 1, wherein the linear electric machine is a closed-cycle engine.

12. An engine body, comprising:
a piston housing; and
a piston arranged in the piston housing and partially defining each of an expansion chamber and a compression chamber within the piston housing, the piston comprising a first portion in thermal contact with the compression chamber, a second portion in thermal contact with the expansion chamber, and a piston body extending from the first portion to the second portion;
wherein the piston body comprises at least one heat shield configured to reduce heat transfer between the expansion chamber and the compression chamber, the at least one heat shield extending from an upper portion of the piston body to a lower portion of the piston body.

13. The engine body of claim 12, wherein the at least one heat shield is spaced from at least one of the second portion and the first portion, the at least one heat shield and the at least one of the first portion and the second portion defining a cavity therebetween configured to reduce the heat transfer between the expansion chamber and the compression chamber.

14. The engine body of claim 12, wherein the piston body further comprises a plurality of heat shields configured to reduce the heat transfer between the expansion chamber and the compression chamber, the at least one heat shield being one of the plurality of heat shields;
wherein the plurality of heat shields are spaced from each other in an longitudinal direction and extending from the upper portion to the lower portion of the piston body;
wherein at least two of the plurality of heat shields define a cavity therebetween configured to reduce the heat transfer between the expansion chamber and the compression chamber.

15. The engine body of claim 14, wherein the cavity extends from the upper portion to the lower portion.

16. The engine body of claim 12, wherein the piston body is in thermal contact with the expansion chamber.

17. A method of manufacturing a piston assembly, the method comprising:
forming a piston housing;
forming a piston body of a piston via additive manufacturing, the piston body comprising at least one heat shield extending from an upper portion of the piston body to a lower portion of the piston body, wherein the at least one heat shield is configured to reduce heat transfer through the piston; and
positioning the piston into the piston housing.

18. The method of claim 17, wherein forming the piston body of the piston comprising the at least one heat shield extending from the upper portion of the piston body to the lower portion of the piston body further comprises utilizing an additive manufacturing process to form the piston body and the at least one heat shield.

19. The method of claim 17, wherein the piston body comprises a plurality of heat shields configured to reduce the heat transfer through the piston, the at least one heat shield being one of the plurality of heat shields, the plurality of heat shields being spaced from each other in an longitudinal direction and extending from the upper portion to the lower portion of the piston body.

20. The method of claim 17, wherein the at least one heat shield partially defines at least one cavity configured to further reduce the heat transfer through the piston, the at least one cavity extending from the upper portion to the lower portion of the piston body.
